(19) United States
(12) Patent Application Publication
(10) Pub. No.: US 2005/0183813 A1
(43) Pub. Date: Aug. 25, 2005

(54) Process for manufacturing a composite sheet

(76) Inventors: James F. Gonsalves, Goshen, IN (US); John A. Wegener, Granger, IN (US); James G. Bledsoe, Goshen, IN (US); Donald C. Ray, Angola, IN (US); Kevin J. Spoo, Newark, OH (US)

Correspondence Address: OWENS CORNING, 2790 COLUMBUS ROAD, GRANVILLE, OH, 43023, US

(21) Appl. No.: 11/060,900

(22) Filed: Feb. 19, 2005

Related U.S. Application Data
(63) Continuation-in-part of application No. 10/062,062, filed on Jan. 31, 2002.

(51) Int. Cl. B32B 31/00

(52) U.S. Cl. 156/245; 156/253; 264/255

(57) ABSTRACT

In a method of manufacturing a composite sheet, a reinforcement panel is provided including an air permeable core and an air impermeable surface layer. Perforations are formed in the reinforcement panel that extend through the surface layer and do not extend through the reinforcement panel. A mold surface is provided onto which the composite sheet may be formed. At least one outer coat of material is applied onto the mold surface. At least one coat of resin and reinforcement material is applied over the outer coat to form a reinforcement layer. The perforated reinforcement panel is applied to the reinforcement layer. Air is removed from the composite sheet.

### CROSS-REFERENCE TO RELATED APPLICATION

This application is a continuation-in-part of U.S. application Ser. No. 10/062,062, filed on Jan. 31, 2002.

### TECHNICAL FIELD

This invention relates in general to a method and apparatus for the manufacture of fiber-reinforced panels, and in particular, to a method and apparatus for the manufacture of a composite sheet suitable for such uses as a recreational vehicle wall.

### BACKGROUND OF THE INVENTION

It is commonplace in the recreational vehicle business to use composite sheets, such as glass fiber-reinforced wall panels, for the exterior surface of a recreational vehicle. These wall panels vary in widths up to, and including, dimensions from 2.4 to 3 meters (8 to 10 feet), and can have a length as long as 12 meters (40 ft.) or more. While the composite material from which the panels are made provides an adequate material for the recreational vehicle side walls, it would be advantageous to provide an improved composite sheet having a stronger bond between respective layers of the composite sheet. It would also be advantageous to manufacture the composite sheet by a method that minimizes production costs.

### SUMMARY OF TH INVENTION

The above objects as well as others not specifically enumerated are achieved by a method of manufacturing a composite sheet according to the present invention. A reinforcement panel is provided including an air permeable core and an air impermeable surface layer. Perforations are formed in the reinforcement panel that extend through the surface layer and do not extend through the reinforcement panel. A mold surface is provided onto which the composite sheet may be formed. At least one outer coat of material is applied onto the mold surface. At least one coat of resin and reinforcement material is applied over the outer coat to form a reinforcement layer. The perforated reinforcement panel is applied to the reinforcement layer. Air is removed from the composite sheet. In a preferred embodiment, the air is removed by drawing the air through the perforations and the core of the reinforcement panel.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic view in elevation, partially in cross section, of an apparatus for manufacturing a composite sheet according to the invention.

FIG. 2 is a schematic view in elevation of an apparatus for perforating panels according to the invention.

FIG. 3 is an enlarged schematic view, partially in cross section, of a perforating pin and the reinforcement panel of FIG. 2.

FIG. 4 is an enlarged cross sectional view in elevation of the composite sheet of FIG. 1 showing a vacuum bag attached to the mold.

FIG. 5 is a cross sectional view in elevation of a portion of the composite sheet of FIG. 4 showing the composite sheet during a vacuuming process.

FIG. 6 is an enlarged cross sectional view in elevation of another embodiment of a composite sheet according to the invention.

FIG. 7 is an enlarged view in elevation of a perforating pin that may be used to form the perforations in the composite sheet of FIG. 6.

FIG. 8 is an enlarged bottom view of the perforating pin of FIG. 7.

### DETAILED DESCRIPTION OF THE INVENTION

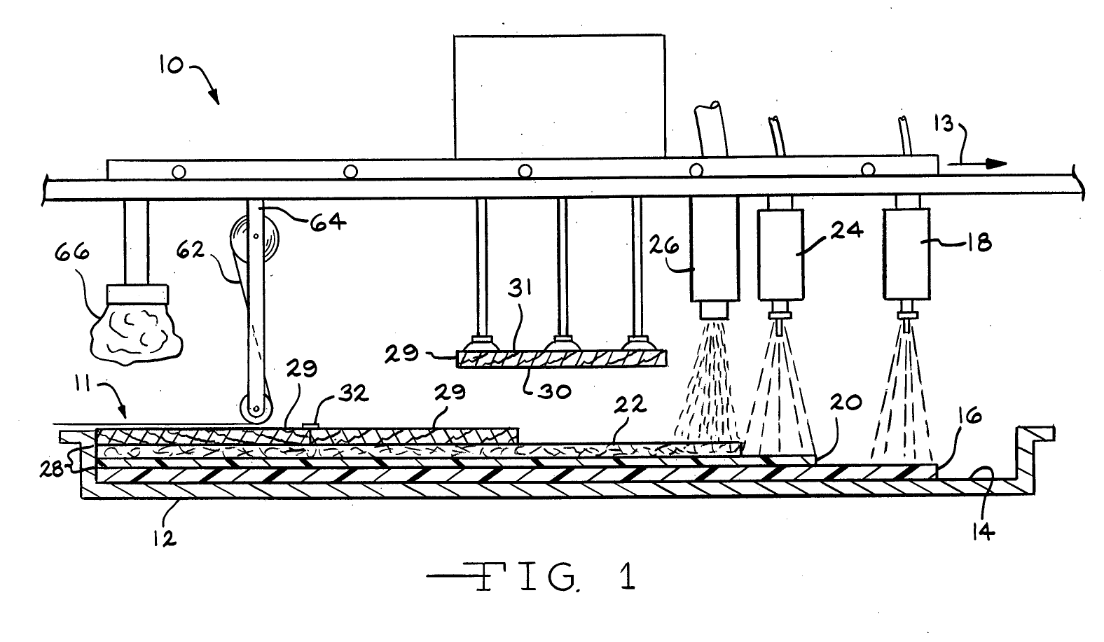

Referring now to the drawings, there is shown in FIG. 1 an apparatus 10 for manufacturing a composite sheet 11 according to the invention. The illustrated manufacturing process involves passing a series of manufacturing operations over an elongate mold 12 in a direction, indicated by the arrow 13 in FIG. 1. The mold 12 is made of any suitable material, such as fiberglass. The mold can be heated or nonheated depending on which works best for a particular process. Typically the mold 12 is somewhat larger than the composite sheet to be made, and large enough to accommodate a 3×12 meter (10×40 ft.) composite sheet. An upwardly facing surface 14 of the mold 12 has a smooth face to provide a substantially flat and smooth surface to the composite sheet 11. The surface 14 forms the exterior surface of the composite sheet to be made.

In a first step of the manufacturing process, an outer coat of material is applied to the surface 14 of the mold 12. Typically, the outer coat is a gel coat 16, but may be any suitable material such as a veneer or a composite material. The gel coat 16 is a commercially available quick setting polymer applied to the surface of a mold. The gel coat 16 cures to form a high gloss exterior surface for the finished composite sheet 11. The gel coat 16 may include a pigment and provides a durable and esthetically pleasing outer surface for the finished composite sheet 11. Preferably, the gel coat 16 is applied in two layers by a sprayer 18. Typically, the sprayer 18 is moved longitudinally along rails and sprays the entire length of the elongate mold 12. Preferably, the sprayer 18 is a conventional sprayer, such as a sprayer commercially available from Magnum Venus of Kent, Wash. The spray head of the sprayer 18 preferably spans transversely across the mold 12 and discharges the gel coat 16 in a spray pattern and with a substantially uniform thickness. Preferably, the gel coat 16 is a polymer having a catalyst which sets up to a gel in about 20 minutes and cures, or hardens, in about 35 minutes. It will be understood that more than one sprayer 18 may be used to apply the gel coat 16, and that other methods for applying the gel coat 16 can be used.

In a second step of the manufacturing process, a composite mixture of resin 20 and reinforcement material, such as chopped fiberglass 22, is applied to the gel coat 16 to form a reinforcement layer 28. The resin 20 may comprise a polymer similar to the gel coat 16, but without a pigment. The resin 20 may be any suitable commercially available polyester resin, such as CoREZYN COR61-AA-830 DCPD laminating resin, from Interplastic Corporation, Minneapolis, Minn. Preferably, however, a polyester/epoxy blend resin having a low shrink characteristic, such as AME 2000 LB 6527-017, from the Ashland Specialty Chemical Company, Composite Polymers Division, Bartow, Fla., will be used. Preferably, the resin 20 is applied by a resin sprayer 24, and the fiberglass 22 is applied by a fiberglass applicator 26. The resin sprayer 24 and the fiberglass applicator 26 are preferably both conventional. The fiberglass applicator 26 is designed for chopping fiberglass fibers 22 and dispensing the chopped fibers 22 in various sizes to form a laminate or reinforcement layer 28 consisting of a mixture of the resin 20 and the fiberglass fibers 22. Such dispensing and spray apparatus may be obtained commercially, for example from Magnum Venus of Kent, Wash. Like the sprayer 18, the sprayer 24 and applicator 26 preferably move longitudinally along rails, span transversely across the mold 12, and discharge resin 20 and chopped fiberglass 22, respectively, in a pattern and with a substantially uniform thickness. It will be understood that more than one resin sprayer 24 and fiberglass applicator 26 may be used to apply the resin 20 and the fiberglass fibers 22. When applying the resin 20 and the chopped fiberglass 22, either the resin 20 or the fiberglass 22 can be applied first, or the resin 20 and the fiberglass 22 can be applied simultaneously. The reinforcement layer 28 may be rolled with weighted rollers (not shown) to remove air from the reinforcement layer 28.

In an alternative embodiment of the invention (not shown), the chopped fiberglass fibers are replaced by a glass mat or other suitable reinforcement material. The mat is applied to the resin in a manner similar to the chopped fiberglass fibers described above. In a further such alternative embodiment, such a glass mat is saturated with the polymer resin 20 and applied on top of the gel coat material 16, thereby eliminating the steps of applying the chopped fiberglass 22 and spraying the resin 20. Furthermore, the mat may comprise nonwoven mat, or a stitched or knitted mat so as to provide strength characteristics as desired.

In a third step of the manufacturing process, a plurality of perforated reinforcement panels 29 are applied to the reinforcement layer 28 in a side-by-side manner. The perforated reinforcement panels 29 are preferably wood panels, typically referred to as luaun. Each panel 29 typically has a thickness of about 3.4 mm and includes a relatively smooth first surface 30 and a relatively rough second surface 31. The first surface 30 of the panel 29 is applied to the reinforcement layer 28. The panels 29 are abutted together along their respective edges. Normally, strips of webbing 32, such as strips of fiberglass mat, are wetted with a catalyzed resin and applied at each seam between the reinforcement panels 29 to reinforce the composite sheet 11. Typically, the reinforcement panels are 1.2×2.4 meter (4 ft.×8 ft.) panels. Thus the 2.4 m (8 ft.) length of the panel 29 corresponds to the width of the composite sheet 11. Although the composite sheet 11 is described as having a plurality of reinforcement panels 29, it will be understood that a continuous reinforcement backing may be provided, thereby eliminating the seams between each panel 29 and eliminating the webbing 32. Such a continuous reinforcement backing may comprise a composite sheet, polymer sheet, foam, coiled steel or aluminum, or other material having the desired properties for a particular application. Additionally, these materials may be used in the form of a plurality of discrete sheets as described with reference to the luaun panels 29. In an alternative embodiment, a fiberglass reinforced plastic (FRP) compound is adhered to a reinforcement board according to the present invention. Such an FRP sheet is commercially available from Kemlite as a Filon panel. Such a panel comprises a known pre-impregnated, glass-fiber-reinforced, unsaturated polyester resin molding compound in dry continuous sheet form sandwiched between two protective layers of polyethylene film. Such an FRP sheet is preferably hot pressed between matched dies against the reinforcement panel 29.

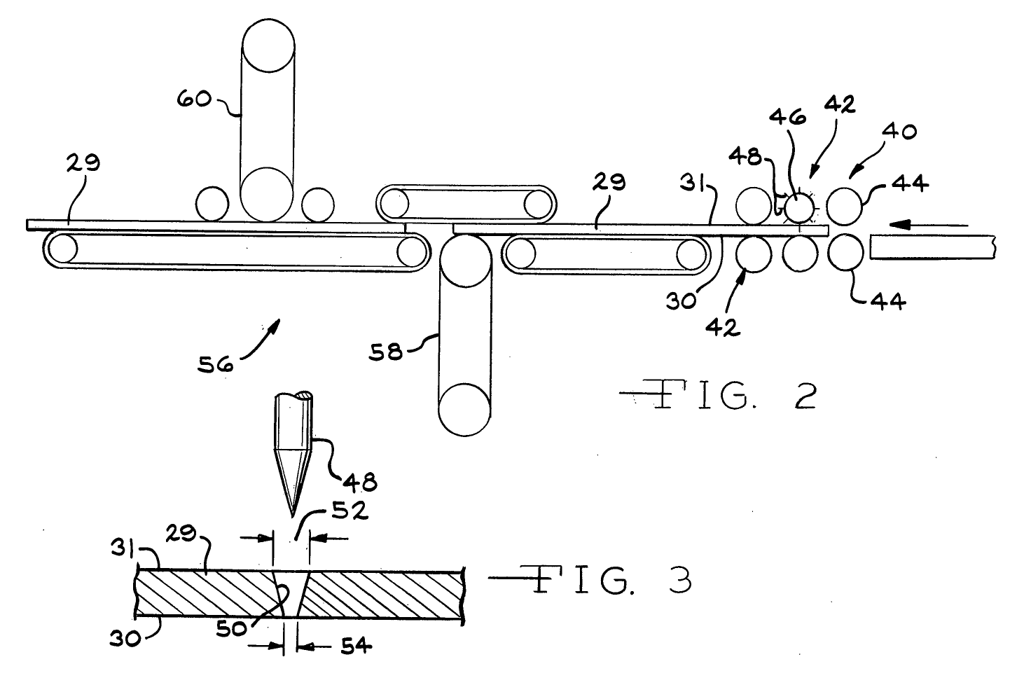

Referring now to FIG. 2, there is illustrated a mechanism for perforating the panels 29, the perforating mechanism being shown generally at 40. The perforating mechanism 40 preferably includes three sets 42 of rollers 44. Each set 42 of rollers includes two opposed pinch-rollers 44. Preferably, one roller of a middle set is a perforating mandrel 46, positioned to be applied against a surface of the reinforcement panel 29. The perforating mandrel 46 illustrated in FIG. 2 is shown as an upper roller in the middle set of rollers 42, however, it will be understood that the perforating mandrel 46 may be a lower roller of the middle set of rollers. Preferably, the reinforcement panel 29 is fed into the perforating mechanism 40, between the opposed pinch-rollers 44 of the sets 42, such that the perforating mandrel 46 is applied against the second surface 31 of the panel 29. Although the perforating mechanism 40 illustrated includes three sets of rollers 42, perforating mechanisms having any suitable number of sets of rollers 42, and any suitable number of perforating mandrels 46 may be used.

The perforating mandrel 46 is similar to the rollers 44, but includes a plurality of perforating pins 48. For reasons that will be explained below, each perforating pin 48 preferably has a tapered or conical shape so as to produce a tapered or conical hole 50. As shown in FIG. 3, each tapered hole 50 preferably includes an opening 54 in the first surface 30 having a diameter within the range of from about 0.8 mm ( 1/32 inch) to about 1.6 mm ( 1/16 inch). More preferably the opening 52 in the first surface 30 has a diameter of about 1.6 mm ( 1/16 inch). The hole 50 also preferably includes an opening 52 in the second surface 31 having a diameter within the range of from about 4.0 mm ( 5/32 inch) to about 4.8 mm ( 3/16 inch). More preferably the opening 52 in the second surface 31 has a diameter of about 4.8 mm ( 3/16 inch). It will be understood that the diameter of the hole 50 may be substantially uniform, such that the diameter of the opening in the first surface 30 is substantially equal to the diameter of the opening in the second surface 31. It is further appreciated that the hole 50 is preferably substantially round, but may comprise a variety of shapes, including for example without limitation an oval, rectangular, or star-shaped hole.

The perforating mandrel 46 is preferably arranged to create a plurality of tapered holes 50 in the reinforcement panel 29 such that the density of holes is within the range of from about 1 hole per square decimeter to about 9 holes per square decimeter (about 4 to about 49 holes per square foot) of reinforcement panel 29. More preferably, the density of holes is within the range of from about 2 holes per square decimeter to about 6 holes per decimeter (about 9 to about 36 holes per square foot) of reinforcement panel 29. Most preferably, the density of holes is within the range of from about 2 holes per square decimeter to about 4 holes per decimeter (about 9 to about 16 holes per square foot) of reinforcement panel 29, such as holes arranged in an evenly spaced 1 decimeter by 1 decimeter (4 inch by 4 inch) grid pattern. It will be understood that the holes 50 may be of any size and density sufficient to evacuate substantially all air trapped between the resin 20 and the reinforcement panel 29 (thereby avoiding regions of trapped air between the resin and reinforcement panel which may be prone to delamination). Furthermore, the panels 29 may comprise substantially thicker panels depending on the application, for example 19 mm ( 3/4 inch) thick plywood sheet may be used in a truck body, and in such a case, the holes 50 are preferably drilled by a perforating mechanism comprising a plurality of drills or punched using a plurality of cylindrical punches.

The perforating mechanism 40 is preferably provided in conjunction with a sander assembly 56. The sander assembly 56 includes a sander 58 arranged to sand the first surface 30 of the panel 29, and may include a second sander 60 arranged to sand the second surface 31 of the panel 29. The first surface 30 contacts the resin 20 and is adhered thereto. The sanders 58 and 60 of the sander assembly 56 can be any conventional sander. Preferably, the perforating mechanism 40 is placed in line with the sanders 58 and 60 of the sander assembly 56. However, it will be understood that the perforating mechanism 40 may be a stand-alone mechanism. After the perforated reinforcement panels 29 have been sanded, they may be stacked or stored until needed. Although shown in FIG. 2 prior to sanding, the mechanism 40 may be provided after the sanders 58 and 60.

Alternatively, although not illustrated, the perforating mechanism could comprise a press having a plurality of pins or a plurality of drills arranged to form the pattern of perforations described above. Furthermore, where the reinforcement panel 29 comprises a composite or foam sheet, the perforation mechanism may comprise a series of pins positioned within the composite or foam material prior to solidification.

In a fourth step of the manufacturing process, a pervious layer of polyester sheet or film 62 (FIGS. 1, 4, and 5) and a layer of nylon mesh (not shown) may be applied to the second surface 31 of the panels 29. The polyester sheet 62 may be applied by a mechanical applicator or feed station 64, or may be applied by hand. Similarly, the nylon mesh may be applied by a mechanical applicator or feed station (not shown) or may be applied by hand. The polyester sheet 62 may be any suitable polyester sheet or film, such as a MYLAR sheet or film (MYLAR is a registered trademark of E.I. Du Pont de Nemours). The polyester sheet 62 and the nylon mesh are applied to the second surface 31 of the panels 29 to facilitate an even evacuation of air during the application of a vacuum, as will be described below. The polyester sheet 62 also helps prevent a vacuum bag 66 from sticking to the reinforcement layer 28. Although the pervious layer 62 is preferably polyester, any sheet of film that will facilitate an even evacuation of air during the application of a vacuum, and that helps prevent the vacuum bag 66 from sticking to the reinforcement layer 28 can be used.

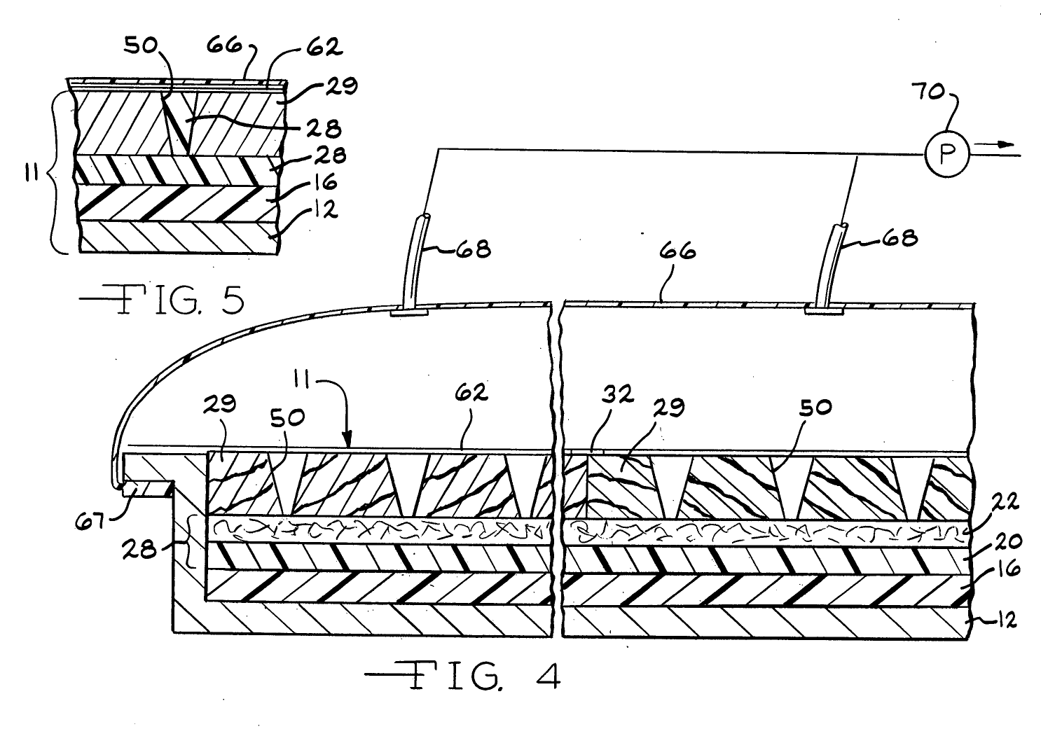

In a fifth step of the manufacturing process, means for applying a vacuum, such as the vacuum bag 66, is placed around the mold 12, as illustrated in FIG. 4. The vacuum bag 66 may be secured to the mold 12 by any suitable means, such as an elastomeric band 67 or clamps (not shown). The vacuum bag 66 includes a plurality of vacuum lines 68. Each vacuum line 68 is connected to a vacuum pump 70. The vacuum pump 70 preferably creates a vacuum pressure within the range of from about 5.0 cm (2.0 in.) Hg to about 7.6 cm (3.0 in.) Hg. More preferably, the vacuum pump 70 creates a vacuum pressure of about 6.3 cm (2.5 in.) Hg. The vacuum pump pulls the air from between the bag 66 and the second surface 31 of the panel 29. The vacuum draws the layers of the composite sheet 11 together, and pulls out any air trapped between the panel 29 and the gel coat 16. During the vacuum process, the trapped air is pulled through the holes 50. In addition, material of the reinforcement layer 28 is forced or pulled into the holes 50, as shown in FIG. 5.

After the reinforcement layer 28 hardens, the vacuum bag 66 is removed from the mold 12. When the composite sheet 11 is fully cured, the sheet 11 is removed from the mold 12. The sheet 11 may be removed from the mold 12 by a lifting mechanism (not shown) and moved to a location for additional processing, such as trimming and inspection.

In an alternative embodiment, vacuum may be applied as described in commonly assigned copending U.S. patent application Ser. No. 10/874,119, filed Jun. 22, 2004, which is incorporated herein by reference in its entirety.

It is known that pockets of air may become trapped between the reinforcement panel 29 and the gel coat layer 16 of the composite sheet 11. More particularly, air may become trapped between the reinforcement panel 29 and the reinforcement layer 28. Such trapped air can cause a distorted appearance on the finished surface 16 of the composite sheet 11, and this results in composite sheets 11 that must be scrapped or remanufactured, adding cost and time to the manufacturing process. The distorted appearance may worsen over time due to the effects of heat related expansion and contraction of both the trapped air and the composite sheet 11.

Many attempts have been made to decrease the amount of air that becomes trapped in the composite sheet 11, such as by increasing the pressure of the vacuum applied to the composite sheet 11 during its manufacture. Typically, a vacuum pressure within the range of from about 25.4 cm (10 in.) Hg to about 30.5 cm (12 in.) Hg is applied to the composite sheet 11. Increasing the vacuum pressure to a level higher than 25.4 to 30.5 cm (10 to 12 in.) Hg has not resulted in a substantial reduction in the occurrence of trapped air pockets in the composite sheet 11.

During testing, composite sheets 11 made with perforated reinforcement panels 29 and composite sheets 11 made with conventional reinforcement panels 29 were exposed to identical varying temperature and environmental conditions. For example, the composite sheets 11 were exposed to a range of worst-case temperature extremes to which the sheets 11 might be subjected to when installed on a vehicle, such as a recreational vehicle.

Surprisingly, it has been shown that the composite sheets 11 manufactured with perforated reinforcement panels 29 had substantially no trapped air pockets, while substantially all the composite sheets 11 manufactured with conventional reinforcement panels had some pockets of trapped air.

It has also been shown that the polyester/epoxy blend resin 20, forming the reinforcement layer 28, flows into and fills the holes 50 during the manufacturing process. It is known that a conventional polyester resin will shrink as the polyester resin cures or hardens. It has also been shown that when such a conventional polyester resin is used with a perforated reinforcement panel 29 of the invention to manufacture a composite sheet 11, disadvantageous depressions or dimples may form in the gel coat 16 opposite each hole 50. Such dimples occur after the polyester resin cures, the resin shrinking toward the hole 50 and toward the second surface 31 of the reinforcement panel 29. Significantly, when the low shrink polyester/epoxy blend resin 20 was used to manufacture a composite sheet 11 having a perforated reinforcement panel 29, substantially no dimples were observed.

As described above, the holes 50 are preferably tapered. It has been shown that such a tapered hole further enhances the appearance of the finished surface of the composite sheet 11. The smaller diameter opening 54 of the tapered hole 50 provides the smallest possible opening diameter on the first surface 30 of the composite sheet 11 such that air may be completely removed, and such that the occurrence of dimples is minimized. It has also been shown that the tapered holes 50, the dimensions of which have been described in detail above, produce fewer burrs in the second surface 31 than similarly manufactured holes having a uniform diameter, thereby minimizing the amount of surface sanding required.

It has also been shown that using perforated reinforcement panels 28 having a plurality of holes arranged in an evenly spaced 1 decimeter by 1 decimeter (4 inch by 4 inch) grid pattern as described above, results in removal of substantially all trapped air. Additionally, it has been shown that the removal of substantially all trapped air occurs at a reduced vacuum pressure, such as a vacuum pressure within the range of from about 5.0 cm (2.0 in.) Hg to about 7.6 cm (3.0 in.) Hg.

It has further been shown that using a reinforcement panel 29 perforated with a plurality of tapered holes 50, results in a composite sheet 11 having a substantially stronger bond between the gel coat 16, reinforcement layer 28, and the reinforcement panel 29, relative to a composite sheet manufactured with a reinforcement panel having a plurality of uniform diameter holes. Using such a perforated reinforcement panel 29 also results in a composite sheet 11 having a substantially stronger bond between the gel coat 16, reinforcement layer 28, and the reinforcement panel 29, relative to a composite sheet manufactured with a reinforcement panel having no perforations.

Although the manufacturing operations, such as the sprayers 18 and 24, and the applicator 26 are illustrated as mounted on a rail positioned above the mold 12, it will be understood that the sprayers 18 and 24, and the applicator 26 may be separately mounted on one or more rails positioned above, below, or in the same plane as the mold 12.

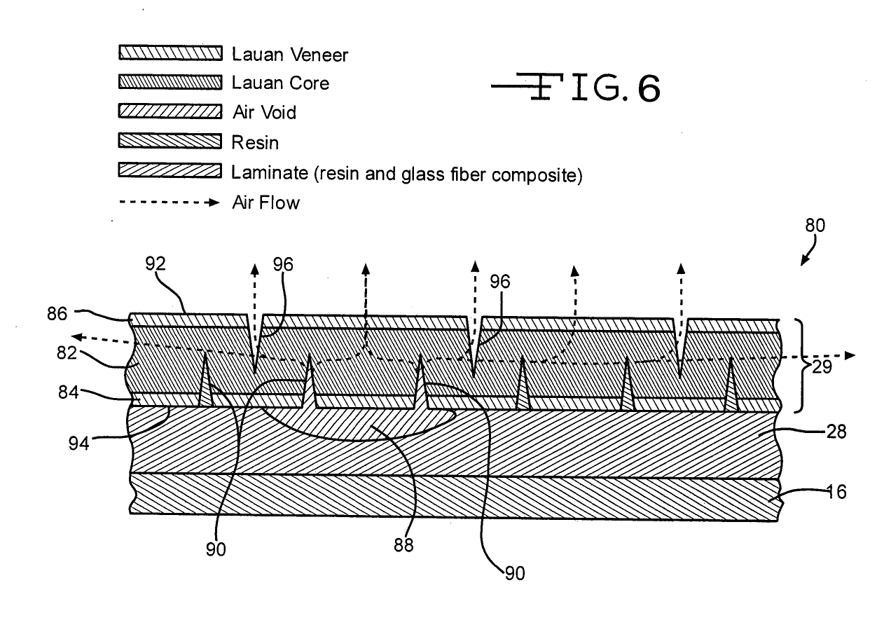

FIG. 6 illustrates another embodiment of a composite sheet 80 according to the invention. The composite sheet 80 is similar to the composite sheet 11 described above. It includes an outer coat of material, such as a gel coat 16. A composite mixture of resin and reinforcement material, such as chopped glass fiber, is applied to the gel coat 16 to form a reinforcement layer 28. A plurality of reinforcement panels 29, one of which is shown from the side in FIG. 6, are applied to the reinforcement layer 28 in a side-by-side manner. Strips of webbing 32, not shown in FIG. 6, are usually applied at each seam between the reinforcement panels 29 to reinforce the composite sheet 80. Alternatively, a continuous reinforcement panel (not shown) may be used in place of the plurality of reinforcement panels 29, thereby eliminating the seams between each panel 29 and eliminating the webbing 32.

The reinforcement panel 29 includes an air permeable core 82 which acts as a manifold for air flow. By “air permeable”, as used herein, is meant that air or other gas is able to flow in a substantial amount through the core 82 when a vacuum pressure of 2.0 in. Hg (5.0 cm Hg) is applied to one side of the core at room temperature (21° C.). Of course, greater or lesser amounts of vacuum may be used depending on the particular process. The core 82 can be made from any material(s) that can form an air permeable core 82. In the embodiment shown, the reinforcement panel 29 is a lauan panel which includes a core 82 made from an air permeable wood.

The reinforcement panel 29 also includes an air impermeable surface layer 84.

By “air impermeable”, as used herein, is meant that no significant amount of air or other gas is able to flow through the surface layer 84 when a vacuum pressure of 2.0 in. Hg (5.0 cm Hg) is applied to one side of the surface layer 84 at room temperature, or alternatively that a void could form adjacent the surface layer 84 due to the inability of the air void 88 to penetrate the surface layer 84 during manufacture of the composite sheet 80. The air impermeable surface layer 84 can be positioned on either side of the core 82. In the embodiment shown, the air impermeable surface layer 84 is positioned adjacent the reinforcement layer 28. The air impermeable surface layer 84 can be made from any material(s) that can form an air impermeable layer 84. In the embodiment shown, the surface layer 84 is a high quality lauan veneer which is an air impermeable wood layer. The lauan panel 29 is preferably an “overlay or better” lauan as known in the lumber industry.

The reinforcement panel 29 also usually includes a second surface layer 86 on the opposite side of the core 82 from the air impermeable first surface layer 84, although such is not required. The second surface layer 86 can be either air permeable or air impermeable. In the embodiment shown, the second surface layer 86 is a lower quality lauan veneer made from wood which is air permeable, although less permeable than the core 82. Alternatively, the second surface layer 86 could be the same veneer as the first surface layer 84.

FIG. 6 shows the composite sheet 80 after assembly of its components but before the method of manufacturing the sheet according to the invention has been completed. It is seen that an air void 88 is present in the reinforcement layer 28 adjacent to the reinforcement panel 29. The existence of air voids 88 between the reinforcement layer 28 and the reinforcement panels 29 increases the risk of delamination of the reinforcement panels 29 from the composite sheet 80. The method of the invention addresses this problem by removing air voids 88 to decrease the risk of delamination. The removal of air voids 88 also decreases the risk of blisters on the composite sheet 80.

To accomplish this, the method includes a step of forming perforations 90 in the reinforcement panel 29 that extend through the air impermeable surface layer 84. However, unlike the holes 50 in the first embodiment of the composite sheet 11 described above, the perforations 90 do not extend completely through the reinforcement panel 29. It has been found that air removal can be successfully achieved so long as the perforations 90 extend through the air impermeable surface layer 84. In the embodiment shown, the perforations 90 also extend a distance into the core 82 of the reinforcement panel 29, although such is not necessary. In a preferred embodiment, the perforations 90 extend into the core 82 and to within a distance from the exterior side surface 92 of the reinforcement panel 29 of between about 0.05 inch and about 0.09 inch, and typically about 0.07 inch. In another embodiment, the perforations 90 extend through the air impermeable surface layer 84 and through the core 82 but do not extend through the second surface layer 84. Unlike perforations 50 that extend through the reinforcement panel 29, the perforations 90 that do not extend through the reinforcement panel 29 do not allow resin to flow from the reinforcement layer 28 onto the exterior surface 92 of the composite sheet 80 when a vacuum is applied to the sheet 80 for the removal of air. This avoids the need for surface sanding of the composite sheet 80 and thereby lowers production costs.

The perforations 90 can have any suitable size and shape, and they can be spaced in any suitable manner, for allowing the removal of air from the composite sheet 80. Preferably, the perforations 90 are tapered as shown in FIG. 6 such that they have a maximum diameter on a side surface of the reinforcement panel 29 (the interior side surface 94 in the embodiment shown) and a minimum diameter inside the reinforcement panel 29. The maximum diameter of the perforations 90 is preferably large enough so that air can be removed from the composite sheet 80, but small enough so that when air is removed from the composite sheet 80, resin from the reinforcement layer 28 does not flow through the perforations 90 and the core 82 and form dimples in the exterior side surface 92 of the reinforcement panel 29. The maximum diameter is preferably within a range of from about 0.01 inch (0.025 cm) to about 0.1 inch (0.25 cm). Preferably, the distance between the perforations 90 is from about 0.5 inch (1.27 cm) to about 1.5 inches (3.81 cm), and typically about 1 inch (2.54 cm). The perforations 90 can be arranged in any suitable pattern, such as a square or diagonal pattern. The perforations 90 are most preferably spaced approximately equidistant from each other; this can be accomplished by any suitable arrangement, such as by positioning the perforations in a diagonal pattern that defines an equilateral triangle between every three perforations.

Perforations 96 may also be formed through the second surface layer 86, as shown in FIG. 6, although such is not necessary. The perforations 96 through the second surface layer 86 may have about the same size, shape and spacing as the perforations 90 through the first surface layer 84. Preferably, as shown in FIG. 6, the perforations 96 are not aligned with the perforations 90.

The perforations 90 and 96 can be formed in the reinforcement panel 29 in any suitable manner. For example, a perforating mechanism 40 similar to that shown in FIG. 2, including a perforating mandrel 46 modified as described below, can be used to form the perforations 90. If such a mechanism 40 is used, the reinforcement panel 29 may be inverted in comparison with FIG. 6 as it is fed through the mechanism, so that the perforating mandrel 46 forms the perforations 90 through the first surface layer 84. If perforations 96 are also formed through the second surface layer 86, the reinforcement panel 29 may be reverted and fed again through the mechanism 40. Alternatively, the perforating mechanism 40 can include perforating mandrels 46 on both the upper and lower sides of the reinforcement panel 29. The positioning of the mandrels 46 may be adjusted so that the perforations 96 do not align with the perforations 90.

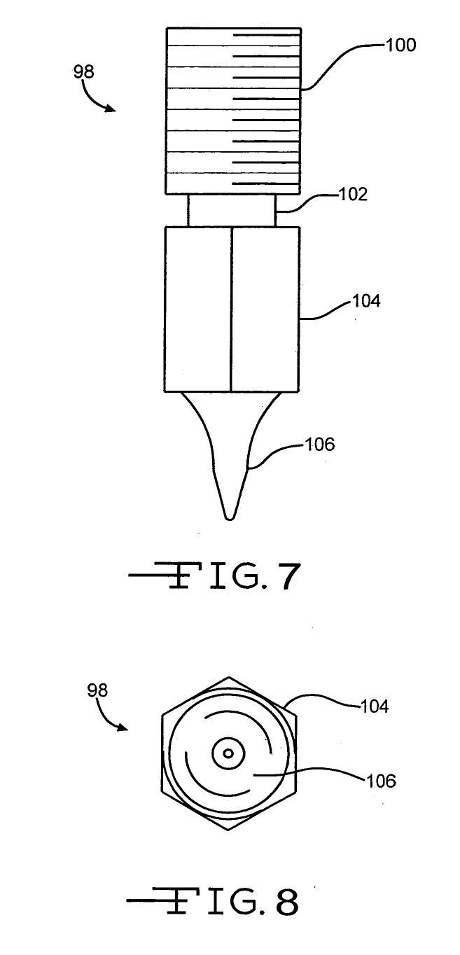

The perforating mandrel 46 is modified so that the perforating pins 48 do not extend completely through the reinforcement panel 29. This can be accomplished by adjusting upward the perforating mandrel 46 so that the pins 48 do not extend completely through the reinforcement panel 29, by using modified perforating pins 98 that are shorter than the perforating pins 48, or both. FIGS. 7 and 8 illustrate a preferred design of a modified perforating pin 98 for use in making the perforations 90 and 96 that do not extend completely through the reinforcement panel 29. The perforating pin 98 includes a threaded base 100 for fastening the perforating pin 98 inside a threaded socket (not shown) of the perforating mandrel 46. A plurality of perforating pins 98 are fastened to the perforating mandrel 46 in such a manner. The perforating pin 98 also includes a neck portion 102 extending from the threaded base 100, and a body portion 104 extending from the neck portion 102. In the embodiment shown, the body portion 104 is hexagonal in shape.

The perforating pin 98 also includes a head portion 106 that forms the perforations 90 and 96 in the reinforcement panel 29. The head portion 106 is shaped and sized to form the desired shape and size of the perforations 90 and 96 as described above. The head portion 106 has a diameter which is small enough such that the perforations 90 and 96 formed have a relatively small maximum diameter as described above. However, if the diameter of the head portion 106 is too small, the head portion 106 is prone to breakage during the perforating operation. Thus, the shape and diameter of the head portion 106 are designed to achieve the desired perforations 90 and 96 while avoiding breakage. The length of the head portion 106 has also been shortened, which further minimizes the risk of breakage.

The perforating mechanism 40 is preferably provided in conjunction with any suitable sanding mechanism, such as the sander assembly 56 described above, to sand the areas on one or both sides of the reinforcement panel 29 where the perforations 90 and optionally 96 were formed.

After the perforated reinforcement panel 29 has been applied to the reinforcement layer 28 in the manufacture of the composite sheet 80, the air 88 is removed from the composite sheet 80. The air 88 can be removed from the composite sheet 80 by any suitable means. By “removed”, as used herein, is meant either that the air 88 leaves the composite sheet 80 without additional action by the manufacturer, or that the manufacturer takes additional action to remove the air 88 (or a combination of both). For example, if the resin in the reinforcement layer 28 is very nonviscous, the weight of the composite sheet 80 may cause the resin to force the air 88 out of the sheet 80, or alternatively, this may be supplemented using a vacuum.

Typically, however, the manufacturer removes the air 88 by drawing the air 88 through the perforations 90 and the core 82 of the reinforcement panel 29. In FIG. 6, the flow of air 88 is indicated by the dotted lines. It is seen that air 88 flows from the air void 88 through the perforations 90 and into the core 82. The air 88 continues flowing through the air permeable core 82. Some of the air 88 may flow through the second surface layer 86 and the perforations 96 (where present) and out of the composite sheet 80, while other air 88 may flow longitudinally through the core 82 until it escapes out the ends of the reinforcement panel 29, and where no second surface perforations 96 are present. The air 88 can be drawn from the composite sheet 80 by any suitable means, and in a preferred embodiment, by evacuating the air 88 using vacuum apparatus such as that described above.

The removal of the air 88 from the composite sheet 80 may force resin from the reinforcement layer 28 to move into the perforations 90 formed through the first surface layer 84 of the reinforcement panel 29. However, in this embodiment of the invention it is not critical that the resin moves into the perforations 90; in some instances the resin may not move into the perforations 90 or may move partway into the perforations 90.

Although not illustrated here, a further alternative embodiment is described which accomplishes the principles of the present invention by providing a reinforcement panel 29 with an inherently porous surface layer 84. In such an embodiment, the reinforcement panel 29 is made from alternative materials and/or processes. In one such embodiment, the panel 29 comprises a fiberboard material, such as MDF, or a chipped board, oriented strand board, or other composite panel with the appropriate properties. In these embodiments, the reinforcement panel 29 has sufficient porosity to enable removal of air between the panel 29 and resin layer as described above, and therefore the reinforcement panel shall be considered to inherently include perforations which accomplish evacuation of the air as described above with respect to the punched holes. Preferably such a construction also uses larger boards than currently available in the industry, since the luaun typically used is available in a limited number of sizes, such as 4 ft. by 8 ft. sheets. In a preferred embodiment, an MDF board having a width in six inch increments is used, such that each board is selected for a width approximately six inches wider than the finished product, as opposed to cutting luaun panels on site to size (width in this instance being the width as measured in the final product, such as e.g. the 10 ft. dimension in the 10×40 composite sheet). When the product using such wide boards is cured, the excess MDF is trimmed in a final cutting operation to final dimensions. Additionally, such MDF is preferably supplied in a length that is greater than the luaun products, and more preferably long enough to avoid any seams (which may form resulting board lines in a finished product) as described in step three above, (e.g. the 40 ft. dimension in the 10×40 sheet) thereby comprising a “continuous reinforcement sheet”. One skilled in the art appreciates that smaller pieces may be necessary for practical commercial purposes, such as e.g. 10×8 ft. sheets, and thereby reduce the seams in the 40 ft. sheet by half in the 40′ dimension.

The principle and mode of operation of this invention have been described in its preferred embodiments. However, it should be noted that this invention may be practiced otherwise than as specifically illustrated and described without departing from its scope. For example, the mold 12 may be movable relative to a plurality of stationary manufacturing operations, such as the gel coat sprayer 16, the resin sprayer 24, and the fiberglass applicator 26, as described in commonly assigned co-pending U.S. patent application Ser. No. 09/997,893, filed Nov. 30, 2001, or may be used in a continuous molding process as described in commonly assigned co-pending U.S. patent application Ser. No. 09/998,731, filed Nov. 30, 2001, both of which are incorporated herein by reference.

1. A method of manufacturing a composite sheet comprising the steps of:
providing a reinforcement panel including an air permeable core and a surface layer;
providing perforations in the reinforcement panel that extend through the surface layer and do not extend through the reinforcement panel;
providing a mold surface onto which the composite sheet may be formed;
applying at least one coat of resin to the mold surface to form a reinforcement layer;
applying the perforated reinforcement panel to the reinforcement layer; and
removing air from the composite sheet.

2. The method of manufacturing a composite sheet according to claim 1 wherein the first surface is initially air impermeable, and the perforations are formed in the panel to penetrate the first layer and the perforations extend into the core.

3. The method of manufacturing a composite sheet according to claim 2 wherein the surface layer of the reinforcement panel is positioned adjacent the reinforcement layer after the reinforcement layer is applied to the mold surface.

4. The method of manufacturing a composite sheet according to claim 3 wherein the surface layer is a first surface layer, wherein the reinforcement panel further includes a second surface layer on the opposite side of the core from the first surface layer, and wherein the perforations are formed to extend through the first surface layer and through the core and to not extend through the second surface layer.

5. The method of manufacturing a composite sheet according to claim 4 wherein the perforations through the first surface layer are first perforations, and wherein the method additionally comprises forming second perforations that extend through the second surface layer, the second perforations being formed so that they are not aligned with the first perforations.

6. The method of manufacturing a composite sheet according to claim 2 wherein the perforations are formed such that the distance between the perforations is from about 0.5 inch (1.27 cm) to about 1.5 inches (3.81 cm).

7. The method of manufacturing a composite sheet according to claim 2 wherein the perforations are tapered such that the perforations have a maximum diameter on a side surface of the reinforcement panel and a minimum diameter inside the reinforcement panel.

8. The method of manufacturing a composite sheet according to claim 8 wherein the maximum diameter of the perforations is from about 0.01 inch (0.025 cm) to about 0.1 inch (0.25 cm).

9. The method of manufacturing a composite sheet according to claim 2 wherein the removal of the air forces the resin into the perforations formed in the reinforcement panel.

10. The method of manufacturing a composite sheet according to claim 9, wherein the air is removed by the use of a vacuum.

11. The method of manufacturing a composite sheet according to claim 2 further comprising a step, after the step of perforating the reinforcement panel, of sanding areas of the surface of the reinforcement panel around the perforations.

12. The method of manufacturing a composite sheet according to any of claims 1-11, further comprising the step of applying at least one outer coat of material to the mold surface, and thereafter applying the resin to the mold over the outer coat material to form the reinforcement layer.

13. The method of manufacturing a composite sheet according to any of claims 1-12, further comprising the step of applying a reinforcement material, said reinforcement material being wet out by said resin to form the reinforcement layer when said resin is cured.

14. The method of manufacturing a composite sheet according to claim 1, wherein the reinforcement panel comprises an inherently porous surface layer.

15. The method of manufacturing a composite sheet according to claim 14, wherein the reinforcement panel comprises a panel selected from the group consisting of a fiberboard panel, an MDF panel, a chipped board panel, an oriented strand board panel and a composite panel.

16. The method of manufacturing a composite sheet according to claim 15, wherein the reinforcement panel is provided in a size to minimize seams in the sheet.

17. The method of manufacturing a composite sheet according to claim 16, wherein the reinforcement panel is a one-piece panel.

18. A method of manufacturing a composite sheet comprising the steps of:
providing a reinforcement panel including an air permeable core and an air impermeable surface layer;
forming perforations in the reinforcement panel that extend through the surface layer and do not extend through the reinforcement panel;
providing a mold surface onto which the composite sheet may be formed;
applying at least one outer coat of material onto the mold surface;
applying at least one coat of resin and reinforcement material over the outer coat to form a reinforcement layer;
applying the perforated reinforcement panel to the reinforcement layer; and
removing air from the composite sheet by drawing air through the perforations and the core of the reinforcement panel.

19. The method of manufacturing a composite sheet according to claim 18 wherein the perforations are formed to extend into the core.

20. The method of manufacturing a composite sheet according to claim 18 wherein the surface layer of the reinforcement panel is positioned adjacent the reinforcement layer.

21. The method of manufacturing a composite sheet according to claim 20 wherein the surface layer is a first surface layer, and wherein the reinforcement panel additionally includes a second surface layer on the opposite side of the core from the first surface layer.

22. The method of manufacturing a composite sheet according to claim 21 wherein the perforations are formed to extend through the first surface layer and through the core and to not extend through the second surface layer.

23. The method of manufacturing a composite sheet according to claim 21 wherein the perforations through the first surface layer are first perforations, and wherein the method additionally comprises forming second perforations that extend through the second surface layer, the second perforations formed so that they are not aligned with the first perforations.

24. The method of manufacturing a composite sheet according to claim 18 wherein the perforations are tapered such that the perforations have a maximum diameter on a side surface of the reinforcement panel and a minimum diameter inside the reinforcement panel.

25. The method of manufacturing a composite sheet according to claim 18 wherein the removal of the air forces the resin into the perforations formed in the reinforcement panel.

26. A method of manufacturing a composite sheet comprising the steps of:
providing a reinforcement panel including an air permeable core and an air impermeable surface layer;
forming perforations in the reinforcement panel that extend through the surface layer and extend into the core and do not extend through the reinforcement panel, the perforations being tapered such that the perforations have a maximum diameter on a side surface of the reinforcement panel and a minimum diameter inside the reinforcement panel;
providing a mold surface onto which the composite sheet may be formed;
applying at least one outer coat of material onto the mold surface;
applying at least one coat of resin and reinforcement material over the outer coat to form a reinforcement layer;
applying the perforated reinforcement panel to the reinforcement layer; and
removing air from the composite sheet by drawing air through the perforations and the core of the reinforcement panel.

27. A method of manufacturing a composite sheet comprising the steps of:
providing a reinforcement panel including an air permeable core and a surface layer;
providing perforations in the reinforcement panel that extend through the surface layer;
providing a mold surface onto which the composite sheet may be formed;
applying at least one coat of resin on the mold surface to form a reinforcement layer;
applying the perforated reinforcement panel to the reinforcement layer; and
removing air from the composite sheet.

28. A method according to claim 27 further comprising the step of forming said perforations in the reinforcement panel.

29. A method according to claim 28 wherein the reinforcement panel further comprises a second surface layer opposite the impermeable surface layer, wherein the forming step comprises forming said perforations through the impermeable layer and terminating said perforations prior to extending through the second surface layer.

30. The method of manufacturing a composite sheet according to claim 29 further comprising the step of applying at least one outer coat of material to the mold surface, and thereafter applying the resin and reinforcement material to the mold over the outer coat material.

31. The method of manufacturing a composite sheet according to claim 30 wherein the surface layer comprises a first surface layer, and the reinforcement panel additionally includes a second surface layer on the opposite side of the core from the first surface layer, wherein the step of forming the perforations comprises forming the perforations to extend through the first surface layer and through the core and terminating said perforations prior to extending through the second surface layer.

32. The method of manufacturing a composite sheet according to claim 31 wherein the perforations through the first surface layer are first perforations, and wherein the method additionally comprises forming second perforations that extend through the second surface layer, the second perforations formed so that they are not aligned with the first perforations.

33. The method of manufacturing a composite sheet according to claim 28 wherein the perforations are formed such that the distance between the perforations is from about 0.5 inch (1.27 cm) to about 1.5 inches (3.81 cm).

34. The method of manufacturing a composite sheet according to claim 28 wherein the perforations are tapered such that the perforations have a maximum diameter on a side surface of the reinforcement panel and a minimum diameter inside the reinforcement panel.

35. The method of manufacturing a composite sheet according to claim 33 wherein the maximum diameter of the perforations is from about 0.01 inch (0.025 cm) to about 0.1 inch (0.25 cm).
